(19) United States
(12) Patent Application Publication
(10) Pub. No.: US 2025/0173589 A1
(43) Pub. Date: May 29, 2025

(54) LEARNING METHOD, INFERENCE METHOD, AND RECORDING MEDIUM STORING PROGRAM

(71) Applicant: Tokyo Electron Limited, Tokyo (JP)

(72) Inventor: Yusuke TSUCHIYA, Hokkaido (JP)

(21) Appl. No.: 18/954,970

(22) Filed: Nov. 21, 2024

(30) Foreign Application Priority Data
Nov. 24, 2023 (JP) 2023-198938

(51) Int. Cl. G06N 5/04

(52) U.S. Cl. CPC G06N 5/04

(57) ABSTRACT

A learning method executed by a computer, includes acquiring data related to a plurality of sensors during occurrence of an abnormality in a substrate processing apparatus, and training a learning model by inputting the data related to the plurality of sensors during the occurrence of the abnormality into the learning model so that an output of the learning model approaches information on a sensor to be analyzed during the occurrence of the abnormality.

### CROSS-REFERENCE TO RELATED APPLICATIONS

This application is based on and claims priority from Japanese Patent Application No. 2023-198938, filed on Nov. 24, 2023, with the Japan Patent Office, the disclosure of which is incorporated herein in its entirety by reference.

### TECHNICAL FIELD

The present disclosure relates to a learning method, an inference method, and a recording medium storing a program.

### BACKGROUND

Japanese Patent Laid-Open Publication No. 2021-068831 proposes a failure detection system that detects a failure of a sensor that detects the status of a semiconductor manufacturing apparatus. The failure detection system includes a generator that generates time series data of information on detection values of a sensor during a determination period, a calculator that calculates a regression line of the time series data, and a failure determiner that determines whether the sensor has failed based on the slope of the regression line.

### SUMMARY

According to one aspect of the present disclosure, a learning method executed by a computer, includes acquiring data related to a plurality of sensors during occurrence of an abnormality in a substrate processing apparatus, and training a learning model by inputting the data related to the plurality of sensors during the occurrence of the abnormality into the learning model so that an output of the learning model approaches information on a sensor to be analyzed during the occurrence of the abnormality.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram illustrating an example of a substrate processing system according to one embodiment.

FIG. 2 is a hardware configuration example of a learning apparatus according to one embodiment.

FIG. 3 is a functional configuration example of a learning apparatus and an inference apparatus according to one embodiment.

FIG. 4 is a flowchart illustrating an example of a learning method according to one embodiment.

FIGS. 5A and 5B are diagrams illustrating an example of evaluation values of sensors according to one embodiment.

FIGS. 6A and 6B are diagrams illustrating an example of sensor-alarm matrix decomposition according to one embodiment.

FIGS. 7A to 7C are diagrams illustrating display examples of an SPC chart.

FIG. 8 is a flowchart illustrating an example of an inference method according to one embodiment.

### DETAILED DESCRIPTION

In the following detailed description, reference is made to the accompanying drawings, which form a part thereof. The illustrative embodiments described in the detailed description, drawings, and claims are not meant to be limiting. Other embodiments may be utilized, and other changes may be made without departing from the spirit or scope of the subject matter presented here.

Hereinafter, embodiments for carrying out the present disclosure will be described with reference to the drawings. In each drawing, the same reference numerals may be given to the same components, and redundant descriptions may be omitted.

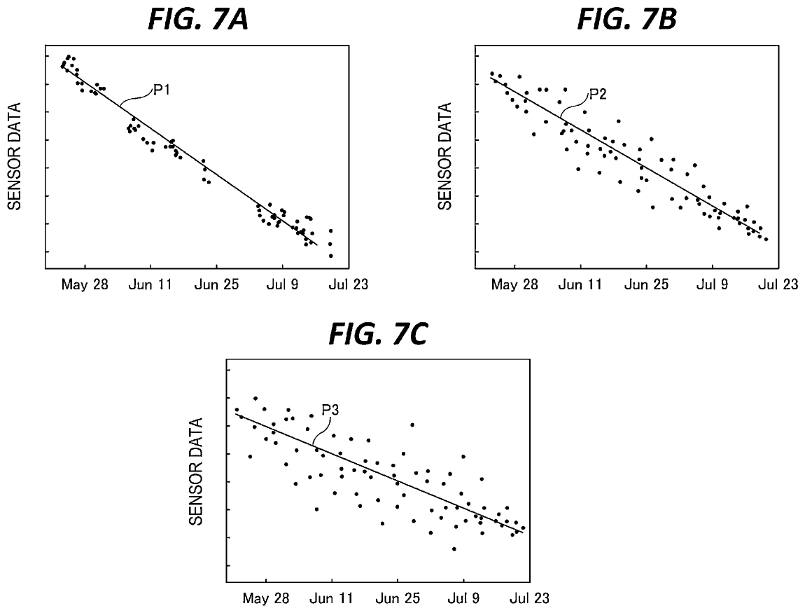

When an abnormality occurs in a substrate processing apparatus, sensor data detected by a sensor mounted on the substrate processing apparatus is analyzed to investigate the cause of the abnormality. During the occurrence of an abnormality in the substrate processing apparatus, a process of acquiring log data related to a sensor, which has been analyzed in the past for the same abnormality, and automatically creating a statistical process control (SPC) chart using the log data is performed. The SPC chart shows a time series change in the statistical values of sensor data (such as the average gas flow rate) (see, e.g., FIGS. 7A to 7C). Experts narrow down sensors that are expected to have errors based on trends indicated by the SPC chart, making these sensors the targets of analysis. Therefore, in this analysis method, experts with knowledge of the substrate processing apparatus need to manually narrow down analysis target sensors to some extent, and then to perform the analysis of an abnormality using sensor data from the narrowed-down sensors.

In contrast, it is also conceivable to perform the analysis of an abnormality using sensor data from all sensors mounted on the substrate processing apparatus without narrowing down analysis target sensors. However, in this case, the processing load on a calculation device is high, and it is undesirable from the perspective of calculation costs. For example, around 1,000 sensors may be mounted on a batch-type substrate processing apparatus and analyzing all of these sensors would lead to an increase in the processing load, which is not realistic.

In the meantime, when narrowing down analysis target sensors in consideration of calculation costs, there is an issue that a method for narrowing down is unclear. Even if the method for narrowing down were clear, there is a challenge that this method depends on the knowledge (hereinafter referred to as domain knowledge) of experts who have experience with the substrate processing apparatus. In addition, domain knowledge refers to knowledge that includes the experiences, intuitions, and other insights of individuals skilled in the use and processes of a substrate processing apparatus 10.

Accordingly, in a learning method and an inference method according to the present embodiment, a method is proposed that allows for the selection of candidates for analysis target sensors without relying on domain knowledge when an abnormality occurs in a substrate processing apparatus. This allows avoidance of an increase in analysis time and calculation costs due to an increase in the number of analysis target sensors, as well as the reliance on domain knowledge when narrowing down the sensors.

### Substrate Processing System

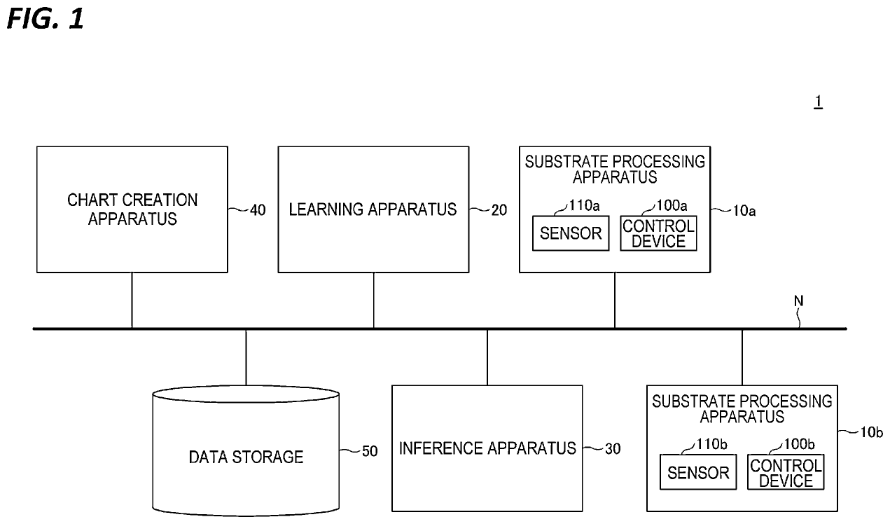

A substrate processing system 1 will be described with reference to FIG. 1. FIG. 1 is a configuration diagram illustrating an example of the substrate processing system 1 according to one embodiment. The substrate processing system 1 includes substrate processing apparatuses 10a and 10b, a learning apparatus 20, an inference apparatus 30, a chart creation apparatus 40, and a data storage 50, all of which are connected to each other to enable data communication via a communication network N such as the Internet or LAN. A control device (100a is incorporated into the substrate processing apparatus 10a, while a control device 100b is incorporated into the substrate processing apparatus 10b. The substrate processing apparatuses 10a and 10b are also collectively referred to as “substrate processing apparatus 10.” The number of substrate processing apparatuses 10 is not limited to two, and may also be one, or three or more.

Sensors 110a and 110b are arranged in the substrate processing apparatuses 10a and 10b, respectively. Each of the sensors 110a and 110b is arranged with, for example, approximately 1,000 units in each of the substrate processing apparatuses 10a and 10b. Examples of the sensors 110a and 110b may include film thickness sensors, temperature sensors, humidity sensors, pressure sensors, vibration sensors, and distance sensors, but are not limited to these. The sensors 110a and 110b are sensors that detect the status of the substrate processing apparatuses 10a and 10b. The sensors 110a and 110b are also collectively referred to as a “sensor 110.”

For example, in the batch-type substrate processing apparatus 10, a boat on which a plurality of wafers are placed is loaded into a processing container (loading), and after the temperature inside the processing container is stabilized, film formation is performed simultaneously on the plurality of wafers placed on the boat. After the film formation, the boat on which the wafers that have undergone the film formation are placed is unloaded from the processing container (unloading). The processing performed by the substrate processing apparatus 10 is not limited to film formation, and may include various types of substrate processing such as etching and sputtering.

The sensor 110 measures the status of the substrate processing apparatus 10 for each event such as loading, temperature stabilization, film formation, and unloading. For example, when the sensor 110 is a pressure sensor, the sensor 110 measures the pressure inside the processing container for each event. For example, when the sensor 110 is a temperature sensor, the sensor 110 measures the temperature inside the processing container for each event. Sensor data such as the temperature and pressure measured by the sensor 110 constitutes time series data of sensor values and is stored in the data storage 50.

The chart creation apparatus 40 acquires necessary data from the data storage 50 during the occurrence of an abnormality in the substrate processing apparatus 10, and automatically creates an SPC chart (see, e.g., FIGS. 7A to 7C) using that data.

The learning apparatus 20 trains a learning model that may select analysis target sensors by inputting learning data and domain knowledge into the learning model, creating a trained model. The inference apparatus 30 uses the trained model to select analysis target sensors, and provides information on the analysis target sensors to the user. This may increase the probability of selecting appropriate analysis target sensors during the occurrence of an abnormality, even if the user does not have domain knowledge. Further, this may eliminate the need for experts with domain knowledge to manually narrow down analysis target sensors, resulting in a reduction in the workload of the experts.

### Hardware Configuration of Learning Apparatus and Inference Apparatus

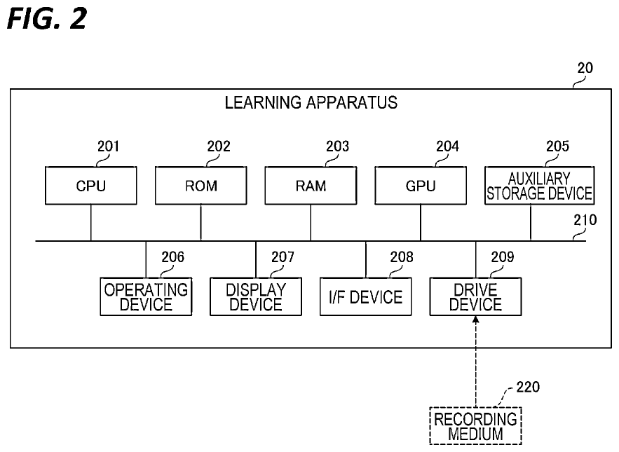

Next, a hardware configuration example of the learning apparatus 20 and the inference apparatus 30 will be described with reference to FIG. 2. FIG. 2 is a diagram illustrating a hardware configuration example of the learning apparatus 20 according to one embodiment. In addition, since the hardware configurations of the learning apparatus 20 and the inference apparatus 30 may be nearly identical, the hardware configuration of the learning apparatus 20 will be described herein, and the description of the hardware configuration of the inference apparatus 30 is omitted.

As illustrated in FIG. 2, the learning apparatus 20 includes a central processing unit (CPU) 201 and a read only memory (ROM) 202. Further, the learning apparatus 20 includes a random access memory (RAM) 203 and a graphics processing unit (CPU) 204. The CPU 201, ROM 202, RAM 203, and GPU 204 form a so-called computer.

Furthermore, the learning apparatus 20 includes an auxiliary storage device 205, an operating device 206, a display device 207, an interface (I/F) device 208, and a drive device 209. In addition, all the hardware components of the learning apparatus 20 are interconnected via a bus 210.

The CPU 201 is a computational device that executes various programs (e.g., an input data generation program and learning program) installed in the auxiliary storage device 205.

The ROM 202 is a non-volatile memory and functions as a main storage device. The ROM 202 stores various programs, data, and others necessary for the CPU 201 to execute various programs installed in the auxiliary storage device 205. Specifically, the ROM 202 stores a boot program such as a basic input/output system (BIOS) or extensible firmware interface (EFI).

The RAM 203 is a volatile memory such as dynamic random access memory (DRAM) or static random access memory (SRAM) and functions as a main storage device. The RAM 203 provides a work area where various programs installed in the auxiliary storage device 205 are executed by the CPU 201.

The GPU 204 is a computational device for image processing and performs image processing computation when a learning program is executed by the CPU 201 based on a learning model. In addition, the GPU 204 is equipped with an internal memory (GPU memory), which temporarily holds information necessary for image processing computation.

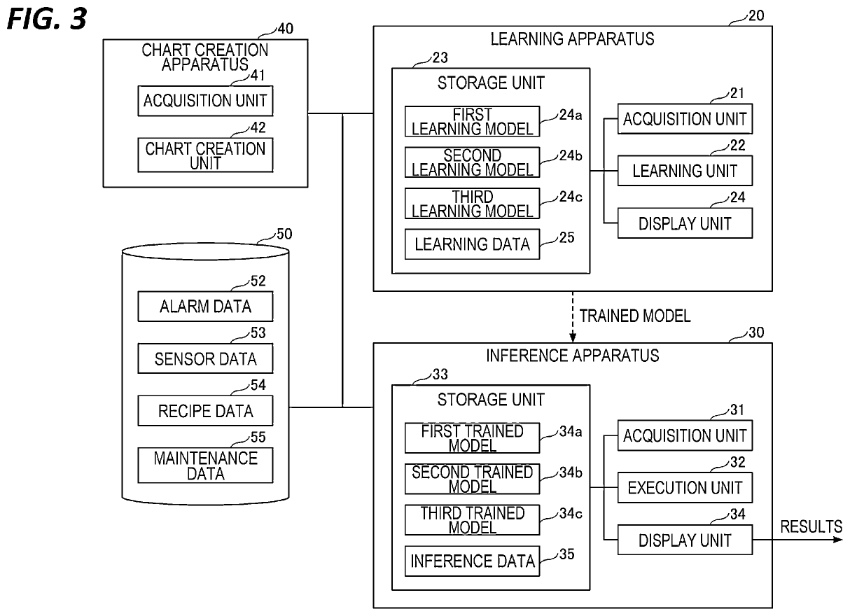

The auxiliary storage device 205 stores learning data and other data to be processed when various programs such as a learning program are executed by the CPU 201. For example, the data storage 50 and a storage unit 23 in FIG. 3 are implemented in the auxiliary storage device 205.

The operating device 206 is an input device used by the administrator of the learning apparatus 20 to input various instructions to the learning apparatus 20. The display device 207 displays the internal status of the learning apparatus 20. The I/F device 208 is a connection device used for connection and communication with other devices.

The drive device 209 is a device for setting a recording medium 220. Here, the recording medium 220 includes media that stores information optically, electrically, or magnetically such as a CD-ROM, flexible disk, and magneto-optical disk. Further, the recording medium 220 may also include a semiconductor memory that electrically stores information such as a ROM or flash memory.

In addition, various programs installed in the auxiliary storage device 205 are, for example, installed by setting the distributed recording medium 220 into the drive device 209, and reading various programs recorded on the recording medium 220 by the drive device 209. Alternatively, various programs installed in the auxiliary storage device 205 may be installed by being downloaded via a network (not illustrated).

### Functional Configuration of Learning Apparatus and Inference Apparatus

Next, a functional configuration example of the learning apparatus 20 and the inference apparatus 30 will be described with reference to FIG. 3. FIG. 3 is a diagram illustrating a functional configuration example of the learning apparatus 20, the inference apparatus 30, and other related components according to one embodiment.

The learning apparatus 20 and the inference apparatus 30 are connected to the chart creation apparatus 40 and the data storage 50. The data storage 50 accumulates alarm data 52 that includes the time of occurrence of an abnormality and the type of alarm when an abnormality occurs during the processing (substrate processing) executed by the substrate processing apparatus 10.

Further, the data storage 50 accumulates sensor data 53 related to the status of the substrate processing apparatus 10 as measured by the sensor 110 and recipe data 54 containing set processing conditions for the substrate processing executed by the substrate processing apparatus 10. The sensor data 53 may contain analysis execution results (such as analyzed sensor evaluation values) for each abnormality and each sensor. The recipe data 54 may contain processing conditions for each step when the processing executed by the substrate processing apparatus 10 is divided into multiple steps. Further, the data storage 50 accumulates maintenance data 55 such as the number of maintenance operations or the maintenance time of the sensor 110.

The learning apparatus 20 includes an acquisition unit 21, a learning unit 22, a storage unit 23, and a display unit 24. The acquisition unit 21 acquires necessary data as learning data from the data storage 50. In the learning apparatus 20, the acquired data is stored as learning data 25 in the storage unit 23. Further, the storage unit 23 stores three levels of learning models (first learning model 24a, second learning model 24b, and third learning model 24c). However, the number of learning models stored in the storage unit 23 may be either one or multiple.

The learning data 25 includes data related to the sensor 110 during the occurrence of an abnormality in the substrate processing apparatus 10. The learning data 25 may also include data related to the processing executed by the substrate processing apparatus 10 during the occurrence of an abnormality. The data related to the sensor 110 during the occurrence of an abnormality may include the sensor data 53 detected by the sensor 110 when the substrate processing apparatus 10 executed the substrate processing during the occurrence of an abnormality. The data related to the sensor 110 during the occurrence of an abnormality may include the evaluation values of the sensor 110 analyzed during the occurrence of an abnormality.

The data related to the processing may include the recipe data 54 that indicates processing conditions when the substrate processing apparatus 10 executes the processing during the occurrence of an abnormality. Furthermore, the data related to the processing may include the maintenance data 55, which is used when the substrate processing apparatus 10 executes maintenance before or after the processing during the occurrence of an abnormality.

By inputting the above-described learning data 25 into the learning model, it is possible to apply abnormality factors that correlate with each event of the substrate processing to the machine learning of the learning model.

A learning program is installed on the learning apparatus 20, and the learning apparatus 20 functions as the learning unit 22 when the learning program is executed.

The learning unit 22 performs machine learning on the learning model using learning data 25 and creates a trained model. The trained model created by the learning unit 22 is output to the inference apparatus 30.

The learning unit 22 inputs the data related to the sensor 110 during the occurrence of an abnormality into the learning model and executes the learning program, thereby training the learning model so that the output of the learning model approaches information on analysis target sensors during the occurrence of an abnormality. The learning unit 22 may further input the data related to the processing executed by the substrate processing apparatus 10 during the occurrence of an abnormality into the learning model, and train the learning model so that the output of the learning model approaches information on analysis target sensors during the occurrence of an abnormality.

The learning unit 22 selects a learning model as a training target from the learning models (first learning model 24a, second learning model 24b, and third learning model 24c) stored in the storage unit 23. The learning unit 22 trains the selected learning model so that the output of the learning model approaches information on analysis target sensors during the occurrence of an abnormality. The learning unit 22 may also select a plurality of learning models. In this case, the learning unit 22 trains each of the plurality of learning models so that the output of each of the plurality of learning models approaches information on analysis target sensors during the occurrence of an abnormality.

The learning unit 22 may select an abnormality as an analysis target in response to user operations or automatically. In this case, the learning unit 22 trains the learning model so that the output of the learning model approaches information on analysis target sensors during the occurrence of the selected abnormality.

In this way, the learning unit 22 trains the learning model so that the output of the learning model allows for the selection of appropriate analysis target sensor information during the occurrence of an abnormality. In other words, by inputting the learning data 25 into the learning model, the learning apparatus 20 performs training to increase the accuracy of sensor narrowing down, ensuring that candidates for analysis target sensors output by the learning model become more appropriate analysis target sensors during the occurrence of the selected abnormality. This enhances the recommendation accuracy of analysis target sensors during the occurrence of an abnormality in the substrate processing apparatus 10.

The display unit 24 outputs the information on the analysis target sensors during the occurrence of an abnormality, which is the learning results of the learning model. For example, the display unit 24 displays an SPC chart of the analysis target sensors output by the learning model.

For example, the user such as an expert with domain knowledge may determine whether candidate sensors are appropriate as analysis target sensors based on trends indicated by the SPC chart, and may provide feedback on the determination result to the learning apparatus 20. The learning unit 22 further trains the learning model so that the output of the learning model corresponds to a sensor selected by the user among the candidate sensors. Thus, the recommendation accuracy of the candidate sensor 110 may be further improved by inputting the domain knowledge of the expert into the learning model. However, the learning method of the learning model is not limited to this, and for example, the appropriateness of analysis target sensors indicated by the SPC chart may be automatically determined based on trends of the SPC chart such as the slope of plotted points, and the automatic determination result may be fed back to the learning apparatus 20.

The trained model generated by performing machine learning in the learning apparatus 20 is installed on the inference apparatus 30. The inference apparatus 30 includes an acquisition unit 31, an execution unit 32, a storage unit 33, and a display unit 34. The acquisition unit 31 acquires the trained model from the learning apparatus 20 and stores it in the storage unit 33. For example, the acquisition unit 31 may store a first trained model 34a, which is a trained model of the first learning model 24a, a second trained model 34b, which is a trained model of the second learning model 24b, and a third trained model 34c, which is a trained model of the third learning model 24c in the storage unit 33.

In other words, in the inference apparatus 30, the storage unit 33 stores trained models (first trained model 34a, second trained model 34b, and third trained model 34c) that have been trained so that the output when data related to the sensor 110 during the occurrence of an abnormality (first abnormality) in the substrate processing apparatus 10 is input approaches information on analysis target sensors during the occurrence of the first abnormality. In the inference apparatus 30, the storage unit 33 may store a trained model that has been trained so that the output when data related to the sensor 110 during the occurrence of the first abnormality in the substrate processing apparatus 10 and data related to the processing (first processing) executed by the substrate processing apparatus 10 during the occurrence of the first abnormality approaches information on analysis target sensors during the occurrence of the first abnormality.

An execution program is installed on the inference apparatus 30, and the inference apparatus 30 functions as the execution unit 32 when the execution program is executed.

The execution unit 32 inputs data related to the sensor 110 during the occurrence of an abnormality (second abnormality) in the substrate processing apparatus 10 into the trained model and executes the execution program, thereby inferring analysis target sensors during the occurrence of the second abnormality. The execution unit 32 may also input data related to the sensor 110 during the occurrence of the second abnormality in the substrate processing apparatus 10 and data related to the processing (second processing) executed by the substrate processing apparatus 10 during the occurrence of the second abnormality into the trained model, and perform the execution program, thereby inferring analysis target sensors during the occurrence of the second abnormality.

The data related to the sensor 110 during the occurrence of the second abnormality may include sensor data detected by the sensor 110 when the substrate processing apparatus 10 executed the second processing during the occurrence of the second abnormality.

The data related to the sensor 110 during the occurrence of the second abnormality may include the evaluation values of the sensor 110 analyzed during the occurrence of the second abnormality.

The data related to the second processing may include recipe data that indicates processing conditions when the substrate processing apparatus 10 executes the second processing. The data related to the second processing may also include maintenance data when the substrate processing apparatus 10 executes maintenance before or after the second processing.

The display unit 34 outputs the inference results of the trained model, which provide information on analysis target sensors during the occurrence of the second abnormality. For example, the display unit 24 displays an SPC chart of analysis target sensors output by the trained model. The SPC chart is created by the chart creation apparatus 40.

The chart creation apparatus 40 includes an acquisition unit 41 and a chart creation unit 42. The acquisition unit 41 acquires data related to an abnormality such as the time of occurrence of an abnormality when the abnormality occurs in the substrate processing apparatus 10. The acquisition unit 41 acquires the alarm data 52 and the sensor data 53 from the data storage 50 during the occurrence of an abnormality in the substrate processing apparatus 10.

The chart creation unit 42 statistically processes the sensor data 53 detected from the substrate processing apparatus 10 before and after the time of occurrence of an abnormality to automatically create an SPC chart that indicates the status of the substrate processing apparatus 10. The chart creation unit 42 uses the alarm data 52 and sensor data 53 acquired by the acquisition unit 41 to automatically create the SPC chart (see, e.g., FIGS. 7A to 7C). The horizontal axis of the SPC chart represents the date and time, while the vertical axis represents the sensor data detected by analysis target sensors (e.g., the average gas flow rate). The average gas flow rate is an example of statistical values, and the sensor data may also be statistical values processed statistically from, for example, standard deviation or other sensor data.

### Learning Method

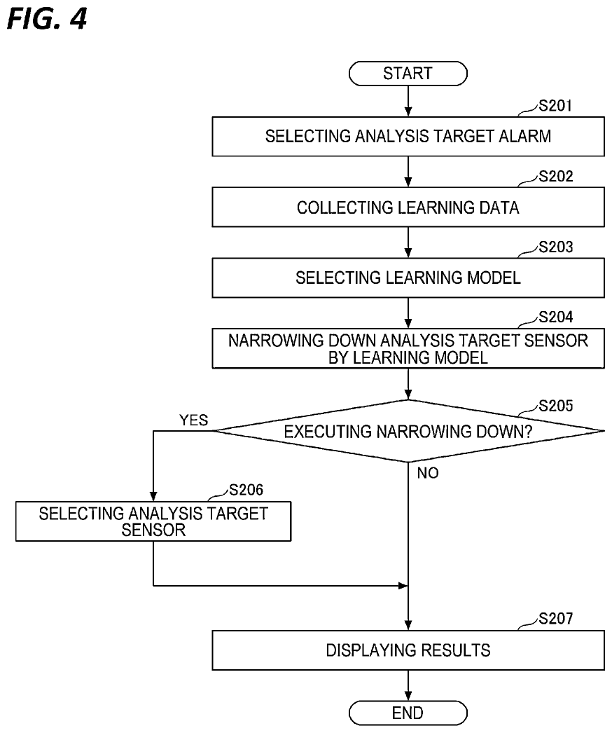

Next, a learning method executed by the learning apparatus 20 will be described. FIG. 4 is a flowchart illustrating an example of a learning method according to one embodiment. When an instruction to perform learning is input, the learning apparatus 20 executes the flowchart illustrated in FIG. 4.

First, in step S201, the learning unit 22 selects an analysis target alarm. However, when this learning method is performed immediately after the occurrence of an abnormality in the substrate processing apparatus 10, the processing in step S201 may be omitted.

Next, in step S202, the acquisition unit 21 collects learning data.

Next, in step S203, the learning unit 22 selects a learning model. The learning unit 22 may select either a single learning model or multiple learning models. When multiple learning models are selected, the learning unit 22 may execute the processing in steps S204 to S207 in parallel for each learning model.

Next, in step S204, the learning unit 22 narrows down analysis target sensors by the learning model, i.e., selects analysis target sensors during the occurrence of an abnormality.

Next, in step S205, the learning unit 22 determines whether to further narrow down analysis target sensors. When the learning unit 22 determines not to execute any further narrowing down, it proceeds to step S207, where the display unit 24 displays the learning results, ending this processing. This allows the user to check the learning results. In the meantime, in step S205, when the learning unit 22 determines that further narrowing down is necessary, it proceeds to step S206, where the expert with domain knowledge such as an operator of the substrate processing apparatus 10 checks information on analysis target sensors narrowed down in step S204 to further select candidates for analysis target sensors, thereby narrowing down information on analysis target sensors (sensor candidates). The sensor candidates may also be further narrowed down by automatically selecting candidates for analysis target sensors. The narrowing-down result is fed back into the learning model as sensor evaluation values to be described later.

After selecting the analysis target sensors, in step S207, the display unit 24 displays the analysis result, ending this processing. This allows the user to check the learning results.

As for a criterion for the learning unit 22 to determine whether to further narrow down analysis target sensors in step S205, there may be a case where the learning unit 22 determines that further narrowing down is necessary in step S205 when the number of analysis target sensors narrowed down in step S204 exceeds a set reference value.

The more data related to sensors during the occurrence of an abnormality that is input into the learning model, the higher the learning accuracy of the learning model becomes. In other words, the amount of data related to sensors during the occurrence of an abnormality is relatively low in the early stages of learning, resulting in lower accuracy for the learning model. Therefore, until the accuracy of the learning model increases, it is desirable to determine in step S205 that further narrowing down analysis target sensors is necessary and to perform this narrowing down of analysis target sensors manually or automatically in step S206.

Through repeated feedback, the recommendation accuracy of sensors by the learning model increases. Therefore, ultimately, further manual or automatic narrowing down of sensors becomes unnecessary. In other words, when the output accuracy of the learning model reaches a certain level and appropriate narrowing down of analysis target sensors (sensor selection) may be achieved in step S204, it may be determined in step S205 that further narrowing down of analysis target sensors is not required.

### Learning Example of First Learning Model

In the learning example of the first learning model 24a, a knowledgeable person manually presets analysis target sensors during the occurrence of an abnormality in the substrate processing apparatus 10. At this time, the knowledgeable person manually presets analysis target sensors for each alarm of the substrate processing apparatus 10. Further, the knowledgeable person may preset analysis target sensors for each event of the substrate processing apparatus 10. The event may correspond to the processing or step included in the recipe data.

The acquisition unit 21 acquires, from the data storage 50, preset analysis target sensors for the same alarm as an abnormality that occurred in the past in the substrate processing apparatus 10 as data related to sensors during the occurrence of an abnormality in the substrate processing apparatus 10. The acquisition unit 21 may also acquire as preset analysis target sensors for an event during the occurrence of an abnormality in the substrate processing apparatus 10 as data related to the processing executed by the substrate processing apparatus 10 during the occurrence of an abnormality.

The learning unit 22 inputs the acquired learning data into the learning model. The learning data may include only data related to sensors during the occurrence of an abnormality in the substrate processing apparatus 10. The learning data may include both data related to sensors during the occurrence of an abnormality in the substrate processing apparatus 10 and data related to the processing performed by the substrate processing apparatus 10 during the occurrence of an abnormality.

The learning unit 22 trains the learning model so that the output of the learning model approaches information on the analysis target sensors during the occurrence of an abnormality, which were preset by the knowledgeable person. The display unit 24 displays the information on the analysis target sensors as the learning results. The display unit 24 outputs, for example, an SPC chart as the learning results.

### Learning Example of Second Learning Model

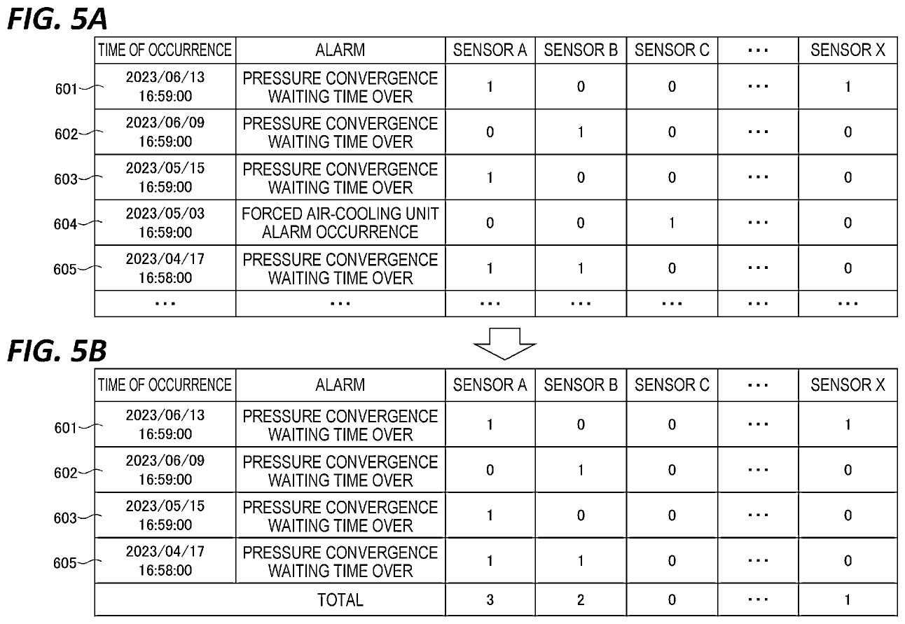

A learning example of the second learning model 24b will be described with reference to FIGS. 5A and 5B. FIGS. 5A and 5B are diagrams illustrating an example of the evaluation values of sensors analyzed during the occurrence of an abnormality according to one embodiment. Data illustrated in FIG. 5A is log data that associates an abnormality that occurred in the past in the substrate processing apparatus 10 with the evaluation values of the analyzed sensors, and is accumulated in the data storage 50. FIG. 5A illustrates the time of occurrence of an abnormality in the substrate processing apparatus 10, the type of alarm, and the evaluation values of sensors A to X analyzed when each alarm occurred. Further, in this learning example, rule information is predefined in the second learning model 24b.

When an analysis target alarm is selected, the acquisition unit 21 collects data related to sensors during the occurrence of an abnormality in the substrate processing apparatus 10 from the data storage 50. For example, when the selected analysis target alarm is “Pressure Convergence Waiting Time Over,” the acquisition unit 21 acquires data 601, 602, 603 and 605 corresponding to the type of alarm “Pressure Convergence Waiting Time Over.” FIG. 5B illustrates an example of the collection results of the learning data.

In addition, the acquisition unit 21 may acquire data related to an event (processing) executed by the substrate processing apparatus 10 during the occurrence of an abnormality. For example, based on the rule information, when an event at the abnormality occurrence time of “2023 Apr. 17 16:59:00” as illustrated in FIG. 5A is an analysis target event (processing), but an event at the abnormality occurrence time of “2023 Apr. 17 16:58:00” is not an analysis target event (processing), the acquisition unit 21 acquires data 601, 602 and 603, excluding data 605, based on the rule information. However, the collection of learning data is not limited to these examples.

In the learning example of the second learning model 24b, the learning unit 22 uses the rule information defined by the second learning model 24b to automatically preset analysis target sensors during the occurrence of an abnormality in the substrate processing apparatus 10. At this time, the learning unit 22 automatically presets analysis target sensors for each alarm of the substrate processing apparatus 10 based on the rule information. Further, the learning unit 22 may automatically preset analysis target sensors for each event of the substrate processing apparatus 10 based on the rule information.

The learning unit 22 inputs the acquired learning data into the learning model. The learning data may include only data related to sensors during the occurrence of an abnormality in the substrate processing apparatus 10. The learning may include both data related to sensors during the occurrence of an abnormality in the substrate processing apparatus 10 and data related to the processing performed by the substrate processing apparatus 10 during the occurrence of an abnormality.

The learning unit 22 trains the learning model so that the output of the learning model approaches information on the analysis target sensors during the occurrence of an abnormality, which were automatically preset based on the rule information. An example of the rule information may define the selection of analysis target sensors based on the evaluation values of sensors corresponding to the same alarm as an abnormality that occurred in the past in the substrate processing apparatus 10. Further, another example of the rule information may define selecting sensors frequently analyzed together with a previously selected analysis target sensor. Further, yet another example of the rule information may define selecting analysis target sensors based on the period since the installation and replacement thereof, prioritizing sensors in the order of those with the longest installation and replacement times.

The display unit 24 displays information on the selected analysis target sensor as the learning results. The display unit 24 outputs, for example, an SPC chart as the learning results.

FIG. 5B illustrates the sum of the evaluation values of each sensor in the learning data. The learning unit 22 trains the learning model so that sensors with higher total evaluation values calculated from the learning data are selected as analysis target sensors based on the rule information. In FIG. 5B, the learning unit 22 predicts that sensor A, which has the highest evaluation value (i.e., the sensor analyzed the most frequently) is likely the cause of an abnormality. The display unit 24 displays information on sensor A and recommends sensor A as an analysis target sensor.

In addition, the sensor evaluation values are not limited to the number of times analyzed. For example, a sensor that has not been analyzed may be set to “0,” while a sensor that was analyzed and was correctly identified as an analysis target sensor, i.e., the cause of an abnormality may be set to “1.”

### Learning Example of Third Learning Model

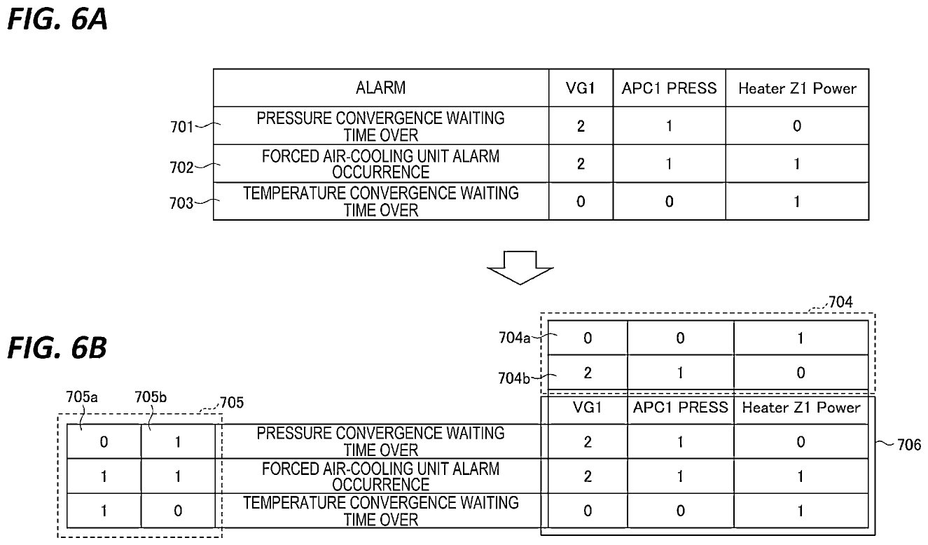

A learning example of the third learning model 24c will be described with reference to FIGS. 6A and 6B. FIGS. 6A and 6B are diagrams illustrating an example of sensor-alarm matrix decomposition according to one embodiment. In the third learning model 24c, it is possible to narrow down analysis target sensors using the matrix decomposition of the sensor-alarm matrix.

The data illustrated in FIG. 6A associates an abnormality that occurred in the past in the substrate processing apparatus 10 with the sensor analysis results, and is accumulated in the data storage 50. In FIG. 6A, the vertical axis represents the type of alarm, while the horizontal axis represents the number of sensor analysis executions for each alarm. The number of sensor analysis executions is an example of the sensor evaluation values.

The acquisition unit 21 collects, for example, data related to sensors during the occurrence of an abnormality in the substrate processing apparatus 10 from the data storage 50. FIG. 6A illustrates an example of the results of collecting the learning data. The acquisition unit 21 may acquire data related to an event (processing) executed by the substrate processing apparatus 10 during the occurrence of an abnormality.

The learning unit 22 uses the third learning model 24c to decompose this numerical data into latent vectors, decomposing it into a latent sensor matrix and a latent alarm matrix. The number of elements k for the latent vectors is optimized. For example, when the number of elements k for the latent vectors is set to 2, the learning unit 22 decomposes data into two latent vectors. As a result, as illustrated in FIG. 6B, data are decomposed into a sensor latent vector matrix 704 in 2 rows and 3 columns and an alarm latent vector matrix 705 in 3 rows and 2 columns.

For example, a first row 704a of the matrix 704 indicates that Heater Z1 power is 1 and Vacuum Generator 1 (VG1) and APC1 Pressure (APC1 PRESS) are 0, which leads to the determination that it pertains to the temperature of the sensor. A second row 704b indicates that Heater Z1 Power is 0, while Vacuum Generator 1 is 2 and APC1 Pressure is 1, which leads to the determination that it pertains to the pressure of the sensor. These determinations are made either manually or automatically.

A first column 705a and a second column 705b of the matrix 705 are determined in the same manner. The first column 705a is data related to the temperature of the alarm, and the second column 705b is data related to the pressure of the alarm. These determinations are made either manually or automatically.

Based on these results, the learning unit 22 reconstructs an evaluation value matrix 706 from the decomposed latent vector matrices 704 and 705. In other words, the reconstructed evaluation value matrix 706 is obtained by the product of the sensor latent vector matrix 704 and the alarm latent vector matrix 705.

In this way, the learning unit 22 inputs the learning data into the learning model, and based on the evaluation value matrix 706 reconstructed using the third learning model 24c, selects an analysis target sensor depending on the type of alarm. In the example of the evaluation value matrix 706 in FIG. 6B, the learning unit 22 selects, as an analysis target sensor, Vacuum Generator 1, which has the highest sensor evaluation value in the row for the type of alarm “Pressure Convergence Waiting Time Over.”

The display unit 24 displays information on the selected analysis target sensor as the learning results. The display unit 24 outputs, for example, an SPC chart.

According to the learning method described above, the more data related to sensors during the occurrence of an abnormality, the higher the learning accuracy of the learning model becomes, which results in an improvement in the accuracy of the trained model along with the operation of the substrate processing apparatus 10.

In particular, automatically reconstructed evaluation values may be obtained in the learning of the third learning model. This makes it possible to discover interactions between features or latent vectors that would be difficult for humans to discover manually. Therefore, the interpretability of the reasons for selecting analysis target sensors is improved, and there is a greater possibility of extracting new analysis target sensor candidates. As a result, the recommendation accuracy of analysis target sensors during the occurrence of an abnormality in the substrate processing apparatus 10 may be improved.

Further, the learning of the third learning model may significantly reduce the processing load and calculation costs. For example, when there are 1,000 sensors and 100 alarms, conventional methods would require 100,000 elements in the evaluation value matrix. Reconstructing 100,000 evaluation values would lead to an increase in processing load and calculation costs, making it impractical.

In contrast, in the learning example of the third learning model 24c, when the number of elements for the latent vectors is set to 3, the sensor latent vector would be represented as a 1000×3 matrix, and the alarm latent vector would be represented as a 100×3 matrix, resulting in an evaluation value matrix with 3,300 elements. By expressing 100,000 evaluation values through matrix decomposition with latent vectors, they may be reduced to 3,300 evaluation values, greatly reducing the processing load and calculation costs.

In addition, the first to third learning models 24a to 24c are merely examples of learning models, and the learning models used for the learning method are not limited to these. A variety of learning models may be proposed depending on the user's tasks and needs, allowing for flexible implementation at different learning levels.

FIGS. 7A to 7C are diagrams illustrating display examples of an SPC chart of sensors. As such, the SPC chart of sensors selected as analysis targets may be displayed as an example of the learning results. The SPC chart is an example of information on analysis target sensors during the occurrence of an abnormality. FIGS. 7A to 7C are graphs of the created SPC chart, where the horizontal axis represents the date and time and the vertical axis plots the statistical values of sensor data from the selected analysis target sensors. The SPC chart illustrates a time series change in sensor data including, for example, the period before or after the occurrence of an abnormality.

For example, it is assumed that three sensors are selected as analysis targets, and the SPC charts of the respective sensors are illustrated in FIGS. 7A to 7C. The SPC chart may be checked manually by the user, or checked automatically, and appropriate analysis target sensors may be selected manually by the user or automatically based on the unevenness or slope of plotted points of sensor data.

The user may also select appropriate sensors based on the slope of plotted points of sensor data in the SPC chart. In this case, since the slope of line P1 in FIG. 7A is steeper than the slopes of lines P2 and P3 in FIGS. 7B and 7C, respectively, and plotted points show unevenness, it may be determined that the SPC chart in FIG. 7A shows a trend, making it suitable as analysis target sensors. Further, the user may determine that the SPC charts in FIGS. 7B and 7C do not show any trend and are unsuitable as analysis target sensors. The learning unit 22 feeds the determination result back into the learning model. This may improve the recommendation accuracy of analysis target sensors during the occurrence of an abnormality in the substrate processing apparatus 10.

This determination may also be made automatically by the learning unit 22. The learning unit 22 may automatically determine the sensor recommendation accuracy from the output SPC chart based on numerical values (such as the sum of squared residuals) that indicate the deviation from plotted points of sensor data.

### Inference Method

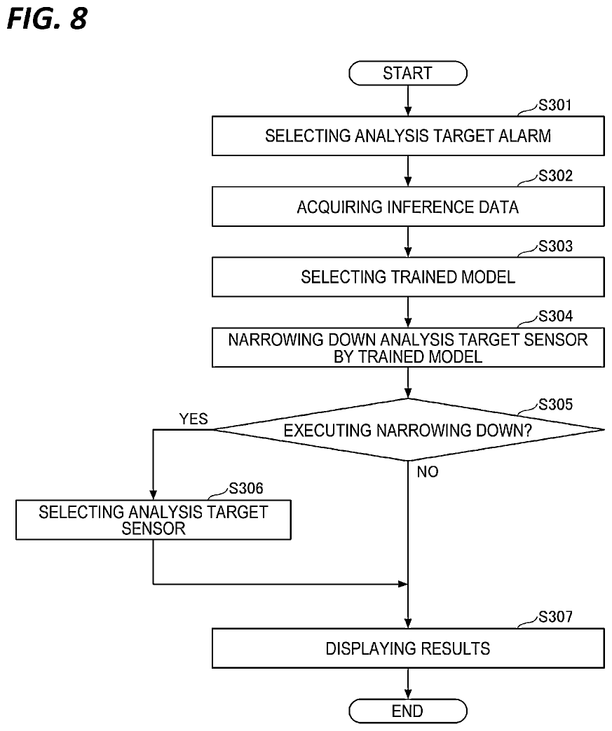

Next, an inference method executed by the inference apparatus 30 will be described with reference to FIG. 8. FIG. 8 is a flowchart illustrating an example of an inference method according to one embodiment. When an instruction to perform inference is input or when an abnormality occurs, the inference apparatus 30 executes the flowchart illustrated in FIG. 8.

The storage unit 33 of the inference apparatus 30 stores a trained model that was trained so that the output when data related to sensors during the occurrence of an abnormality (first abnormality) in the substrate processing apparatus 10 is input approaches information on analysis target sensors during the occurrence of the first abnormality.

First, in step S301, the learning unit 22 selects an analysis target alarm. However, when this inference method is performed immediately when an abnormality (second abnormality) occurs in the substrate processing apparatus 10, the processing in step S301 may be omitted.

Next, in step S302, the acquisition unit 31 acquires inference data 35. For example, the acquisition unit 31 acquires, as the inference data 35, data related to sensors when the second abnormality occurs in the substrate processing apparatus 10. The inference data 35 may include sensor data related to the status of the substrate processing apparatus 10 detected by sensors when a second processing was executed by the substrate processing apparatus 10 during the occurrence of the second abnormality. It may also include the evaluation values of sensors analyzed during the occurrence of the second abnormality.

The inference data 35 may include data related to a second processing executed by the substrate processing apparatus 10 during the occurrence of the second abnormality. The data related to the second processing may include recipe data that indicates processing conditions when the substrate processing apparatus 10 executes the second processing. The data related to the second processing may also include maintenance data when the substrate processing apparatus executes maintenance before or after the second processing.

Next, in step S303, the learning unit 22 selects a trained model. The learning unit 22 may select either a single trained model or multiple trained models. When multiple trained models are selected, the learning unit 22 may execute the processing in steps S304 to S307 in parallel for each trained model.

Next, in step S304, the learning unit 22 narrows down analysis target sensors by the trained model, i.e., selects analysis target sensor candidates.

Next, in step S305, the learning unit 22 determines whether to further narrow down the analysis target sensors. When the learning unit 22 determines not to execute any further narrowing down, the display unit 34 displays the analysis results in step S307. The user checks the analysis results. In the meantime, when the learning unit 22 determines that further narrowing down is required, in step S306, for example, the expert with domain knowledge may check the analysis target sensors narrowed-down in step S304, selects candidates for the analysis target sensors, and further narrows down the candidates. The analysis target sensor candidates may also be selected and further narrowed down automatically. The results of this narrowing down are fed back into the trained model as sensor evaluation values.

As for a criterion for the learning unit 22 to determine whether to further narrow down analysis target sensors in step S305, there may be a case where the learning unit 22 determines that further narrowing down analysis target sensors is necessary in step S305 when the number of analysis target sensor candidates narrowed down in step S304 is large.

After selecting the analysis target sensors, in step S307, the display unit 34 displays the analysis results. The user checks the analysis results. The display unit 24 outputs, for example, an SPC chart as an example of information on analysis target sensors during the occurrence of an abnormality. FIGS. 7A to 7C are diagrams illustrating display examples of the SPC chart of sensors. As such, by displaying the SPC chart of selected analysis target sensors, the user may easily determine whether the recommended sensors are appropriate as analysis targets.

For example, the learning data 25 to be collected is not limited to the alarm data 52 and the sensor data 53. When information on analysis target sensors during the occurrence of an abnormality is desired based on recipes used by the substrate processing apparatus 10, the learning data 25 may include the alarm data 52, recipe data 54, and sensor data 53. Further, when information on maintenance performed before or after the occurrence of an abnormality is to be considered, the learning data 25 may include the alarm data 52, maintenance data 55, and sensor data 53. This allows for the learning of the learning model in consideration of factors such as a high likelihood of sensor failure when the number of maintenance increases, or a low likelihood of failure when the sensor has been recently maintained.

The substrate processing system 1 illustrated in FIG. 1 is merely an example, and various system configurations are possible depending on the application and purpose. For example, in FIG. 1, the learning apparatus 20 and the inference apparatus 30 are illustrated as separate information processing apparatuses, but they may be the same information processing apparatus. Further, the chart creation apparatus 40 is illustrated as a separate information processing apparatus from the learning apparatus 20 and the inference apparatus 30, but may be implemented as a function built into the learning apparatus 20 and the inference apparatus 30.

The substrate processing apparatus of the present disclosure may be applied to any of a single wafer apparatus for processing substrates one by one, and a batch apparatus and semi-batch apparatus for collectively processing a plurality of substrates. Further, the substrate processing apparatus may be applied to any type of substrate processing apparatuses that do not generate a plasma such as a thermal processing apparatus. Furthermore, the substrate processing apparatus may also be applied to plasma processing apparatuses such as atomic layer deposition (ALD), capacitively coupled plasma (CCP), inductively coupled plasma (ICP), radial line slot antenna (RLSA), electron cyclotron resonance plasma (ECR), and helicon wave plasma (HWP) apparatuses.

According to one aspect, it is possible to provide a method for improving the recommendation accuracy of an analysis target sensor during the occurrence of an abnormality in a substrate processing apparatus.

From the foregoing content, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A learning method executed by a computer, the method comprising:
acquiring data related to a plurality of sensors during occurrence of an abnormality in a substrate processing apparatus; and
training a learning model by inputting the data related to the plurality of sensors during the occurrence of the abnormality into the learning model, so that an output of the learning model approaches information on a sensor to be analyzed during the occurrence of the abnormality.

2. The learning method according to claim 1, wherein the data related to the plurality of sensors during the occurrence of the abnormality includes sensor data detected by the plurality of sensors when the substrate processing apparatus performs a processing during the occurrence of the abnormality.

3. The learning method according to claim 1, wherein the data related to the plurality of sensors during the occurrence of the abnormality includes an evaluation value of the sensor that has been analyzed during the occurrence of the abnormality.

4. The learning method according to claim 1, further comprising:
acquiring data related to a processing performed by the substrate processing apparatus during the occurrence of the abnormality,
wherein, in the training, the data related to the plurality of sensors during the occurrence of the abnormality and the data related to the processing are input into the learning model, and the output of the learning model approaches the information on the sensor to be analyzed during the occurrence of the abnormality.

5. The learning method according to claim 1, wherein the data related to the processing includes recipe data indicating a processing condition when the substrate processing apparatus performs the processing during the occurrence of the abnormality.

6. The learning method according to claim 1, wherein the data related to the processing includes maintenance data when the substrate processing apparatus performs maintenance before or after the processing during the occurrence of the abnormality.

7. The learning method according to claim 1, further comprising:
outputting the information on the sensor to be analyzed during the occurrence of the abnormality using the learning model.

8. The learning method according to claim 7, wherein the learning model is trained to output the information on the sensor to be analyzed during the occurrence of the abnormality, the sensor to be analyzed being selected by a user or selected automatically from sensor-related information which has been output.

9. The learning method according to claim 7, wherein the sensor-related information is a statistical process control (SPC) chart related to the analysis target sensor.

10. An inference method executed by a computer, the method comprising:
storing a trained model that has been trained in which an output when data related to a plurality of sensors during an occurrence of a first abnormality in the substrate processing apparatus is input, approaches information on a sensor to be analyzed during the occurrence of the first abnormality; and
inferring the sensor to be analyzed during an occurrence of a second abnormality while inputting data related to the plurality of sensors during the occurrence of the second abnormality in the substrate processing apparatus into the trained model.

11. The inference method according to claim 10, wherein the data related to the plurality of sensors during the occurrence of the second abnormality includes sensor data related to a status of the substrate processing apparatus detected by the plurality of sensors when the substrate processing apparatus performs a processing during the occurrence of the second abnormality.

12. The inference method according to claim 10, wherein the data related to the plurality of sensors during the occurrence of the second abnormality includes an evaluation value of a sensor analyzed during the occurrence of the second abnormality.

13. The inference method according to claim 10, further comprising:
storing the trained model that has been trained so that an output when the data related to the plurality of sensors during the occurrence of the first abnormality and data related to a first processing performed by the substrate processing apparatus during the occurrence of the first abnormality approaches the information on the sensor to be analyzed during the occurrence of the first abnormality,
wherein in the inferring, the data related to the plurality of sensors during the occurrence of the second abnormality in the substrate processing apparatus and data related to a second processing performed by the substrate processing apparatus during the occurrence of the second abnormality are input into the trained model.

14. The inference method according to claim 13, wherein the data related to the second processing includes recipe data indicating a processing condition when the substrate processing apparatus performs the second processing during the occurrence of the abnormality.

15. The inference method according to claim 13, wherein the data related to the second processing includes maintenance data when the substrate processing apparatus performs maintenance before or after the second processing during the occurrence of the abnormality.

16. The inference method according to claim 10, further comprising:
outputting information on the sensor to be analyzed during the occurrence of the second abnormality using the trained model.

17. The inference method according to claim 16, wherein the information on the sensor to be analyzed is a statistical process control (SPC) chart related to the analysis target sensor.

18. A non-transitory computer-readable recording medium having stored therein a program that causes a computer to execute a process comprising:
storing a trained model that has been trained so that an output when data related to a plurality of sensors during an occurrence of a first abnormality in a substrate processing apparatus is input approaches information on a sensor to be analyzed during the occurrence of the first abnormality; and
inferring a sensor to be analyzed during an occurrence of a second abnormality while inputting data related to a plurality of sensors during the occurrence of the second abnormality in the substrate processing apparatus into the trained model.
